(19) United States
(12) Patent Application Publication
(10) Pub. No.: US 2007/0089358 A1
(43) Pub. Date: Apr. 26, 2007

(54) Garden edging

(76) Inventor: Mark J. Verkamp, Charlesten, AR (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/257,994

(22) Filed: Oct. 26, 2005

(51) Int. Cl. A01G 1/08

(52) U.S. Cl. 47/33

(57) ABSTRACT

A garden edging including a corrugated strip of sheet metal and a guard capping the corrugated strip. The guard includes a metal clip having a crosspiece from the opposite ends of which a pair of legs extends downwardly in the form of an inverted “U”. A plastic coating covers the clip. The coating is formed so as to have a pair of ribs that project inwardly toward one another from the bottoms of the legs for gripping the corrugated strip.

### FIELD OF THE INVENTION

The present invention relates generally to plant husbandry and, more particularly, to apparatus for use in establishing and maintaining ornamental beds.

### BACKGROUND OF THE INVENTION

Unless checked, the grass forming a lawn will creep into adjacent garden beds choking growth there. Thus, edging materials have long been used in yards to separate lawns from beds containing flowers, shrubs, and trees. These materials have included plastic and metal strips of sufficient height to prevent grass roots from passing beneath the strips when inserted into the ground. While such strips are generally up to the task, at least in the short term, they are not particularly durable and require replacement every few years.

### SUMMARY OF THE INVENTION

In light of the problems associated with the known edging materials of the sort employed in and around lawns and gardens, it is a principal object of the invention to provide a garden edging that is: virtually impervious to weathering, not prone to damage when trod upon, suitable for use in all types of soil, and long lived.

It is another object of the invention to provide garden edging of the type described that is kind to the eyes of passersby and will not harm their feet if inadvertently stepped upon.

It is a further object of the invention to provide garden edging of the type described that is easy to install with basic tools yet firmly anchors itself in the ground.

It is an object of the invention to provide improved elements and arrangements thereof in garden edging for the purposes described that is lightweight in construction, inexpensive to manufacture, and dependable in use.

Briefly, the garden edging in accordance with this invention achieves the intended objects by featuring a corrugated strip of sheet metal and a guard capping the corrugated strip. The guard includes a metal clip having a crosspiece from the opposite ends of which a pair of legs extends downwardly in the form of an inverted “U”. The guard also includes a plastic coating covering the clip. The coating is formed so as to have a pair of ribs that project inwardly toward one another from the bottom ends of the legs for gripping the corrugated strip. A staple anchors the corrugated strip to the ground.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side elevational view of garden edging in accordance with the present invention with portions broken away to reveal details thereof.

FIG. 2 is a cross-sectional view of the garden edging taken along line 2-2 of FIG. 1 and shown being installed in the ground.

FIG. 3 is a perspective view of the garden edging with portions thereof being broken away.

FIG. 4 is a bottom view of the garden edging with portions thereof being broken away.

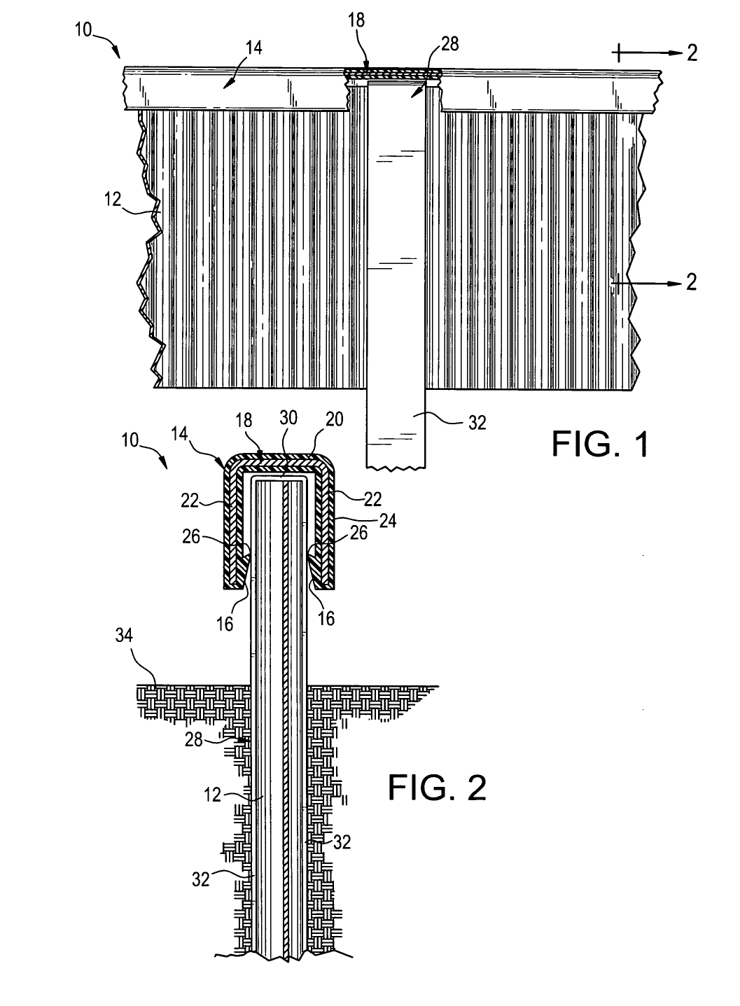

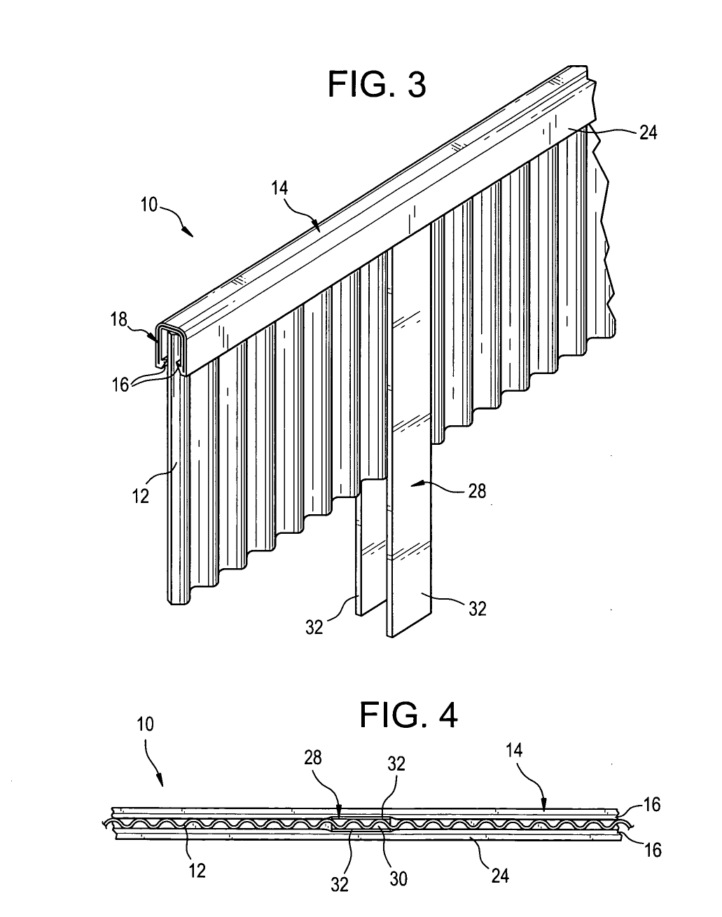

Similar reference characters denote corresponding features consistently throughout the accompanying drawings.

### DETAILED DESCRIPTION OF THE PREFERRED EMBODIMENT

Referring now to the FIGS., garden edging in accordance with the present invention is shown at 10. Edging 10 includes a corrugated strip 12 formed of sheet metal that is capped with a resilient guard 14. Guard 14 is provided with gripping means in the form of a pair of opposed ribs 16 for preventing the easy removal of guard 14 from the top of corrugated strip 12 once installed thereon.

Corrugated strip 12 is cut from steel sheet stock of suitable gauge. Preferably, corrugated strip 12 measures about 4 inches (10.2 cm) in height and 20 feet (6.1 m) to 40 feet (12.2 m) in length. The width of corrugated strip 12 is set by the amplitude of the corrugations, about ¼ inch (6.4 mm), and the wavelength of the corrugations, about 7/16 inch (1.1 cm) which provide excellent stiffness to corrugated strip 12 upon installation yet provide good resiliency for handling. In this regard, corrugated strip 12 is rolled for easy storage and transport prior to installation.

Corrugated strip 12 is coated to inhibit corrosion. Coatings can be applied by galvanizing and/or painting. Paints are applied in colors that are harmonious to a garden environment such as green, brown, and white. It is possible that paints of different colors can be applied to opposite sides of corrugated strip to match, for example, the green of a lawn on one side and the brown of a mulched bed on the other for optimum harmony in a landscaped environment.

Guard 14 includes an aluminum clip 18 shaped like an inverted “U” and having a crosspiece 20 from the opposite ends of which a pair of legs 22 extend downwardly. Clip 18 is covered by a resilient coating 24 comprising a PVC polymer, having a color that complements corrugated strip 12, to enhance the grip of guard 14 upon corrugated strip 12. As shown, coating 24 is molded such that it has a pair of ribs 16 that project inwardly toward one another from the bottom ends of legs 22. Each of ribs 16 terminates at an upwardly projecting barb 26 that serves to catch upon the opposite sides of corrugated strip 12 when corrugated strip 12 is pressed between legs 22 thereby preventing the easy separation of corrugated strip 12 and guard 14. Model 1350-¼ edge trim produced by Trim-Lok, Inc., of Buena Park, Calif., measuring about 11/16 inch (1.7 cm) by ¼ inch (6.4 mm), is suitable for use as guard 14.

A staple 28 is employed to anchor corrugated strip 12 to the ground. Staple 28 is 10 shaped like an inverted “U” and includes a crossbar 30 from the opposite ends of which a pair of elongated struts 32 extend downwardly. Like corrugated strip 12, staple 28 is cut from steel sheet stock so that it has a width of about 1 inch (2.54 cm) and has a length of about 6 inches (15.2 cm) and is formed using conventional metal sheet forming techniques and can be coated to enhance its longevity. Preferably, staple 28 is dimensioned to snugly engage the top and sides of corrugated strip 12 and is locked atop corrugated strip 12 by guard 14 that is slipped over the top of staple 28 at the time of installation of garden edging 10.

The use of garden edging 10 is straightforward. First, with a spade (not shown), a narrow slot about 3 inches (7.6 cm) deep is cut in the earth at a location where it is desired to install garden edging 10. Then, corrugated strip 12 is positioned in the slot. Should strip 12 not have a length sufficient to reach the end the slot, a second strip 12 can be overlapped for a few inches (cms) against the first so that the full length of the slot is traversed by strip material. Next, at intervals of every 3 feet (1 m) or so, staples 28 are positioned over the top of strip 12 and driven into the ground 34 to affix strip 12 in place. Afterward, guard 14 is pressed downwardly on top of strip 12 thereby covering staples 28 and any strip overlaps. The entire process requires just a few minutes to complete, but garden edging 10 will effectively work outdoors for years to come.

During its period of use, edging 10 will exclude grass from flowerbeds or other areas where it is not desired. Barefooted passersby who happen to step upon edging 10 will not be harmed thereby since the top of corrugated strip 12 is covered by guard 14. The likelihood that edging 10 can become disassembled during use is minimal since guard is held tightly in place by ribs 16.

While garden edging 10 has been described with a high degree of particularity, it will be appreciated by those skilled in the art that modifications may be made to it. Therefore, it is to be understood that the present invention is not limited to the sole embodiment described above, but encompasses any and all embodiments within the scope of the following claims.

I claim:

1. A garden edging, comprising:
a corrugated strip of sheet metal; and,
a guard capping said corrugated strip, said guard including:
a metal clip having a crosspiece from the opposite ends of which a pair of legs extends downwardly in the form of an inverted “U”; and,
a plastic coating covering said clip, said coating being formed to have a pair of ribs that project inwardly toward one another from the bottoms of said legs for gripping said corrugated strip.

2. The garden edging according to claim 1 further comprising a staple for anchoring said corrugated strip to the ground, said staple including:
a crossbar for positioning atop said corrugated strip and beneath said guard; and,
a pair of struts extending downwardly from said crossbar on opposite sides of said corrugated strip to points below said corrugated strip.
